(19) United States
(12) Patent Application Publication
(10) Pub. No.: US 2016/0350869 A1
(43) Pub. Date: Dec. 1, 2016

(54) METHOD AND SYSTEM FOR TRACKING FOREIGN TRANSACTIONS

(71) Applicant: MasterCard International Incorporated, Purchase, NY (US)

(72) Inventors: Arun ELANGOVAN, Astoria, NY (US); Jeremy PASTORE, Brooklyn, NY (US); Michael ZHAO, New York, NY (US)

(73) Assignee: MasterCard International Incorporated, Purchase, NY (US)

(21) Appl. No.: 14/724,116

(22) Filed: May 28, 2015

(51) Int. Cl. G06Q 40/00

(52) U.S. Cl. CPC G06Q 40/123

(57) ABSTRACT

A method for assisted declaration of goods at customs includes: storing, in a mobile communication device, algorithms associated with the calculation of a duty amount based on rules or regulations; receiving, by the mobile communication device, a plurality of transaction data entries, each entry being related to a payment transaction involving a consumer and including transaction data; identifying, in the mobile communication device, at least one transaction data entry involving the purchase of one or more declarable goods based on the rules or regulations; calculating, by the mobile communication device, a duty amount based on application of the rules or algorithms to the transaction data included in the identified at least one transaction data entry; and transmitting, by the mobile communication device, the calculated duty amount.

### FIELD

The present disclosure relates to the tracking of foreign transactions, specifically the tracking of foreign transactions for delivery of transaction data to a mobile device for assistance in the declaration of goods and calculations of duty fees at customs.

### BACKGROUND

When traveling to a different country, consumers may often purchase goods to bring back to their home country, such as souvenirs, local crafts or foodstuffs, mementos, etc. In some instances, consumers may purchase local goods in the country they are visiting for resale in their home country. In any instance, upon return to their home country, the consumer is often required to declare the goods they are bringing in from the visited country, and may often be required to pay a duty, or tax, on the goods.

However, such a process can be both cumbersome and difficult for both consumers and customs agents alike. For consumers that might take longer trips, it may be difficult to remember the number of transactions and their amounts that must be declared to the customs officials. In addition, due to the varying rules in different jurisdictions as to what must be declared, and what value may be attributed to certain transactions, the calculation of any duty amount that must be paid may be difficult. Not only does this inconvenience consumers, but it can also slow down the process of going through customs, which may inconvenience the customs agents, as well as any other travelers going through customs at the same time.

In addition, many countries require the consumers themselves to identify transactions and goods that must be declared and to calculate any duty amounts owed based on those declarations. The custom agents often either accept the consumer's declarations and calculations without checking them, which can lead to mistakes, non-compliance and loss of income, or can check the work of the consumer, which adds additional time and frustration to the experience. As a result, the existing system for identifying declarations for going through customs can be inconvenient, inaccurate and time consuming for both the consumers and the customs agents themselves.

Thus, there is a need for a technical solution to assist in the identification of transactions for declaration to customs, as well as the calculation of duty amounts that must be paid. In addition, providing additional assistance as to the payment of duty amounts as well may result in a system that is more efficient than existing practices, more accurate, and more convenient for each party involved. By streamlining the process via use of a mobile communication device, consumers can return to their home country and have transactions automatically identified, and in some cases also automatically declared and duty amounts automatically calculated, and in further cases payments automatically made to the customs agency, to greatly increase the quickness of the customs process as well as increase the accuracy of declarations to the advantage of both the consumers and the customs agencies.

### SUMMARY

The present disclosure provides a description of systems and methods for assisted declarations of goods at customs.

A method for assisted declaration of goods at customs includes: storing, in a memory of a mobile communication device, one or more algorithms associated with the calculation of a duty amount based on one or more rules or regulations; receiving, by a receiving device of the mobile communication device, a plurality of transaction data entries, wherein each transaction data entry is related to a payment transaction involving a consumer and includes at least transaction data; identifying, in the mobile communication device, at least one transaction data entry of the plurality of transaction data entries as involving the purchase of one or more declarable goods based on the one or more rules or regulations; calculating, by a processing device of the mobile communication device, a duty amount, wherein the duty amount is based on at least application of the stored one or more rules or algorithms to the transaction data included in the identified at least one transaction data entry; and transmitting, by a transmitting device of the mobile communication device, at least the calculated duty amount.

A system for assisted declaration of goods at customs includes: a memory of a mobile communication device configured to store one or more algorithms associated with the calculation of a duty amount based on one or more rules or regulations; a receiving device of the mobile communication device configured to receive a plurality of transaction data entries, wherein each transaction data entry is related to a payment transaction involving a consumer and includes at least transaction data; a processing device of the mobile communication device configured to identify at least one transaction data entry of the plurality of transaction data entries as involving the purchase of one or more declarable goods based on the one or more rules or regulations, and calculate a duty amount, wherein the duty amount is based on at least application of the stored one or more rules or algorithms to the transaction data included in the identified at least one transaction data entry; and a transmitting device of the mobile communication device configured to transmit at least the calculated duty amount.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for assisted declaration of goods at customs in accordance with exemplary embodiments.

FIG. 2 is a block diagram illustrating the mobile device of FIG. 1 for assisting in the declaration of goods and calculation of duty amounts at customs in accordance with exemplary embodiments.

FIG. 3 is a flow diagram illustrating a process for assisting in the declaration of goods and payment of duty amounts at customs in accordance with exemplary embodiments.

FIG. 4 is a flow diagram illustrating a process for assisted declaration of goods at customs using the mobile device of FIG. 2 in accordance with exemplary embodiments.

FIGS. 5A-5D are diagrams illustrating a graphical user interface of the mobile device of FIG. 2 for assistance in the declaration of goods and payment of duty amounts to customs in accordance with exemplary embodiments.

FIG. 6 is a flow chart illustrating an exemplary method for assisted declaration of goods at customs in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

### System for Assisted Declaration of Goods

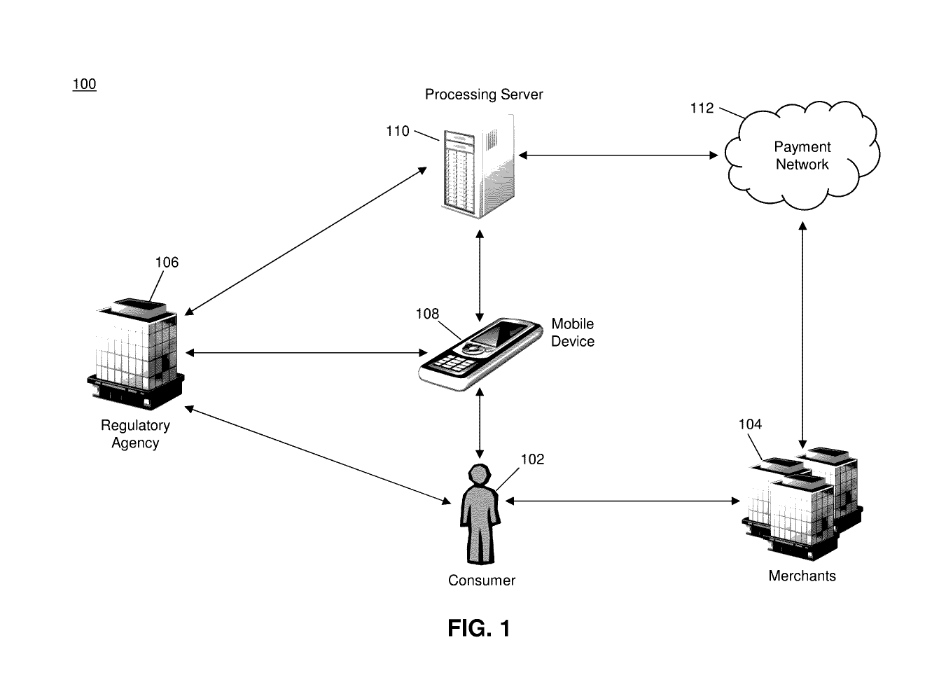

FIG. 1 illustrates a system 100 for the assisted declaration of goods at customs and the payment of duty amounts using a mobile device.

In the system 100, a consumer 102 may conduct one or more payment transactions to merchants 104 while visiting another country. Some of the payment transactions may be for the purchase of goods or services that must be declared at customs when returning to their home or other destination country. Some of the payment transactions may be for the purchase of goods or services that do not need to be declared at customs at the destination country. The payment transactions may be processed by a payment network 112. For example, the payment transactions may be funded using one or more payment cards or other payment instruments associated with the consumer 102, and processed accordingly by the payment network 112.

Transaction data for the payment transactions involving the consumer 102 may be transmitted to a processing server 110. The processing server 110 may be one or more computing systems, servers, devices, etc. configured to perform functions discussed herein. In some embodiments, the processing server 110 may be a part of the payment network 112. In other embodiments, the processing server 110 may be a part of a regulatory agency 106, such as a customs agency, that is associated with the declaration of goods in the destination country. In additional embodiments, the processing server 110 may be part of a third party entity, such as one that assists consumers in the declaration of goods and calculation of duty amounts using the methods and systems discussed herein.

The consumer 102 may possess a mobile device 108. The mobile device 108, discussed in more detail below, may be a mobile communication device configured to assist in the declaration of transactions and/or goods, the calculation of duty amounts, the payment of duty amounts, and additional functions discussed herein, such as a cellular phone, smart phone, tablet computer, notebook computer, laptop computer, wearable computing device, smart watch, etc. When the consumer 102 enters the destination country, the processing server 110 may provide transaction data for payment transactions conducted with merchants 104 in the visited country to the mobile device 108. In some embodiments, the mobile device 108 may automatically detect when the consumer 102 has returned to the destination country and may request transaction data from the processing server 110. In other embodiments, the consumer 102 may initiate a request for the transaction data, such as by opening an application program stored on the mobile device 108 and configured to perform the functions discussed herein. In another embodiment, the processing server 110 may detect when the mobile device 108 has entered the destination country and may push the transaction data to the mobile device 108.

Once the mobile device 108 receives the transaction data for the foreign (e.g., conducted with merchants 104 in the visited country) transactions, the mobile device 108 may be configured to assist the consumer 102 in the declaration of goods and/or transactions to assist in the customs process. In some instances, the mobile device 108 may identify foreign transactions for presentation to the consumer 102, and the consumer 102 may select transactions that must be declared. In some cases, the mobile device 108 may provide product data for products purchased in the foreign transactions for selections by the consumer 102 of individual products that are to be declared. In some instances, the mobile device 108 may be configured to suggest transactions for the consumer 102 to declare, such as based on rules set forth by the regulatory agency 106.

In some embodiments, the mobile device 108 may be configured to automatically identify transactions and/or goods for declaration. For instance, the mobile device 108 may be programmed with one or more rules or algorithms for the identification of transactions and/or goods, such as based on rules set forth by the regulatory agency 106. In such an embodiment, the mobile device 108 may provide the consumer 102 with the automatically identified declarations for confirmation by the consumer 102, such that the consumer 102 may remove or add transactions or products to the list of transactions and/or products being declared.

The mobile device 108 may also be configured to calculate a duty amount. The duty amount may be calculated using one or more rules or algorithms and may be based on transaction amounts or product amounts for the transactions and products being declared, as identified by the consumer 102 and/or the mobile device 108. The duty amount may also be based on any rules or regulations set forth by the regulatory agency 106 in the destination country, such as specifying what products or transactions result in the owing of a duty amount, a tax rate for products and/or transactions, etc. One the duty amount is calculated, the mobile device 108 may present the amount to the consumer 102. The consumer 102 may then pay the duty amount to the regulatory agency 106 as part of the customs process.

In some embodiments, the mobile device 108 may be configured to convey data to the regulatory agency 106 using one or more methods. For instance, in one example, the mobile device 108 may be configured to generate a barcode or other optical machine readable indicia encoded with information, such as declared transaction data, the calculated duty amount, etc., which may be presented to the regulatory agency 106 or an agent thereof via a display screen on the mobile device 108. The regulatory agency 106 may read the barcode and thereby obtain the declaration information for the consumer 102. In some embodiments, the mobile device 108 may include payment details in the barcode, such as details associated with a transaction account associated with the consumer 102. In such an embodiment, the regulatory agency 106 may process a transaction for the duty amount using the read payment details.

In another embodiment, the mobile device 108 may be configured to transmit the declaration information, duty amount, and/or payment details directly to a computing device or system of the regulatory agency 106 using one or more methods or systems that will be apparent to persons having skill in the relevant art. For example, the mobile device 108 may communicate the data to the regulatory agency 106 using near field communication, or other radio frequency communication, Bluetooth, etc. In another example, the data may be transmitted to a device configured to print a customs form that includes the declaration information. In such an instance, the consumer 102 and regulatory agency 106 may be quickly provided with a proper customs form that is accurate and easily readable, without the need to modify existing regulatory agency 106 systems for processing.

In some embodiments, the mobile device 108 may be configured to initiate payment of the duty amount to the regulatory agency 106. For example, an application program stored on the mobile device 108, and configured to identify the declarations and calculate the duty amount, may be further programmed to enable the consumer 102 to provide payment details or to otherwise obtain payment details (e.g., from a mobile wallet application stored on the mobile device 108) and may be programmed to initiate a payment transaction to the regulatory agency 106 for the duty amount. For instance, the mobile device 108 may initiate a credit card payment, a wire transfer, etc. to the regulatory agency 106 for the duty amount. In such embodiments, the mobile device 108 may provide a notification for presentation to a customs agent by the consumer 102 to confirm payment, such as a confirmation number, receipt, etc.

The mobile device 108, using the methods and systems discussed herein, may be configured to greatly assist consumers 102 in the declaration of goods and transactions at customs. By receiving transaction data for foreign transactions when the consumer 102 arrives at the destination country, and presenting them to the consumer 102, the mobile device 108 can greatly increase the speed of the customs process, and can also increase the accuracy of the consumer's declarations. Furthermore, additional features disclosed herein may even further increase the efficiency, accuracy, and speed of the customs process, by calculating duty amounts for the consumer 102, quickly providing relevant information to the regulatory agency 106, and even initiating payment of the duty amount directly from the mobile device 108. As a result, the methods and systems discussed herein provide a plurality of technical advantages over existing methods for declaring goods at customs.

### Mobile Device

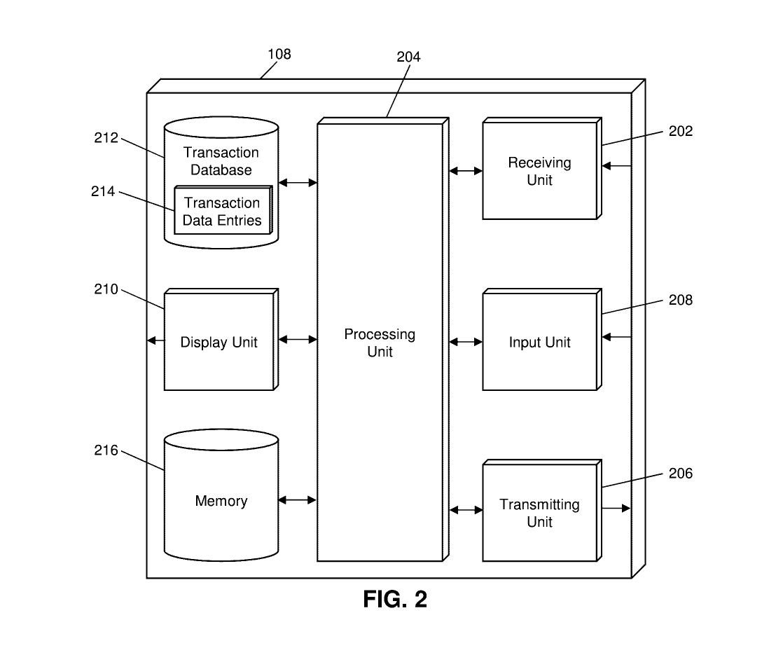

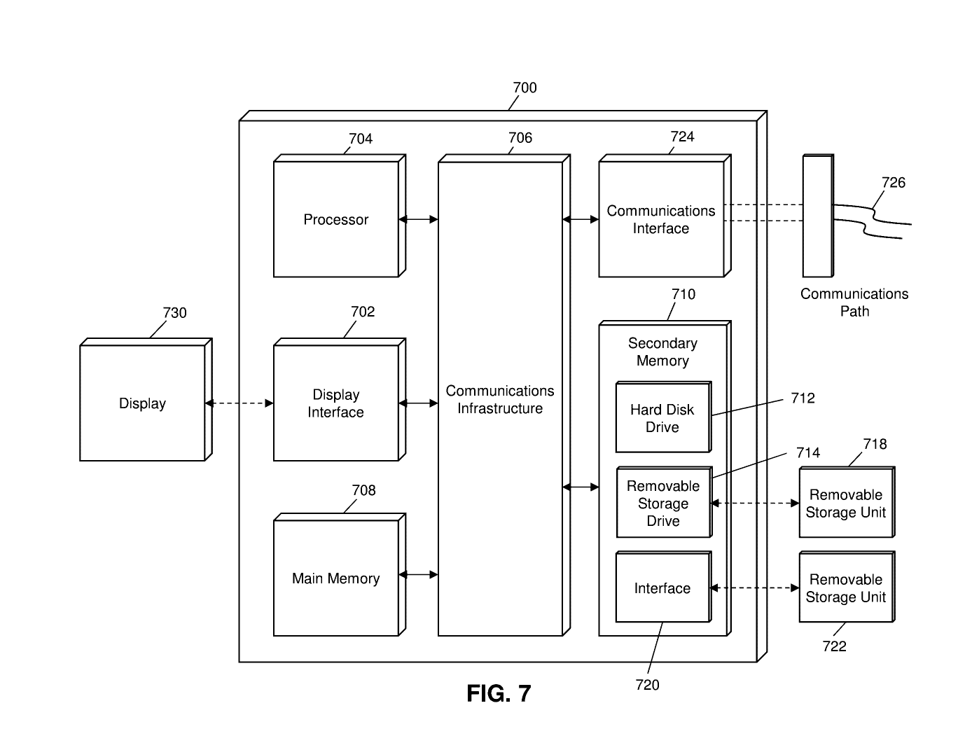

FIG. 2 illustrates an embodiment of the mobile device 108 of the system 100. It will be apparent to persons having skill in the relevant art that the embodiment of the mobile device 108 illustrated in FIG. 2 is provided as illustration only and may not be exhaustive to all possible configurations of the mobile device 108 suitable for performing the functions as discussed herein. For example, the computer system 700 illustrated in FIG. 7 and discussed in more detail below may be a suitable configuration of the mobile device 108.

The mobile device 108 may include a receiving unit 202. The receiving unit 202 may be configured to receive data over one or more networks via one or more network protocols. For example, the receiving unit 202 may be configured to receive transaction data from the processing server 110, such as via a mobile communication network, local area network, etc. In some instances, the receiving unit 202 may be specially configured to receive transaction data via transaction messages, which may be specially formatted and/or communicated pursuant to one or more applicable standards, such as the ISO 8583 standard for the interchange of transaction messages. The receiving unit 202 may also be configured to receive rules and/or algorithms for the identification of goods and/or transactions and the calculation of duty amounts, such as from the regulatory agency 106 or as part of an application program configured to perform the functions disclosed herein.

The mobile device 108 may also include a processing unit 204. The processing unit 204 may be configured to perform the functions of the mobile device 108 discussed herein as will be apparent to persons having skill in the relevant art. In some embodiments, the processing unit 204 may be configured to perform the functions via instructions included in an application program executed by the processing unit 204, such as an application program specially configured to perform the functions disclosed herein. The processing unit 204 may store transaction data received by the receiving unit 202 in a transaction database 212.

The transaction database 212 may include a plurality of transaction data entries 214. Each transaction data entry 214 may be configured to store data related to a payment transaction including, for example, a transaction amount, merchant identifier, merchant category code, product data, geographic location, transaction time and/or date, payment data, offer data, loyalty data, etc. In some instances, the transaction database 212 may be included in a special memory located in the mobile device 108, such as an encrypted database, a Secure Element, or other type of secure storage.

The processing unit 204 may be configured to identify foreign transactions included in the transaction database 212. In some embodiments, the processing server 110 may only transmit foreign transaction data to the mobile device 108. In such an embodiment, each transaction data entry 214 stored in the transaction database 212 may be related to a foreign (e.g., conducted outside of the destination country) transaction. In other embodiments, the processing unit 204 may identify foreign transactions based on geographic locations, transaction times and/or dates, etc. included in the transaction data entries 214. For example, if the processing unit 204 identifies that the mobile device 108 has entered a destination country, using one or more methods apparent to persons having skill in the relevant art, the processing unit 204 may be configured to identify a previous country and a length of stay (e.g., based on additional location data) and may be configured to identify transaction data entries 214 whose transaction data correspond to the previous country and length of stay.

Once foreign transactions have been identified, the mobile device 108 may present the transactions to the consumer 102 via a display unit 210. The display unit 210 may be any type of display unit suitable for the display of data to a consumer 102 that will be apparent to persons having skill in the relevant art, such as a liquid crystal display, light emitting diode display, capacitive touch display, thin film transistor display, etc. In some embodiments, the processing unit 204 may be configured to first identify transactions and/or products for declaration by the consumer 102. In such an instance, the transactions may be presented to the consumer 102 pre-declared, or with recommended transactions indicated.

The consumer 102 may then select and/or confirm what transactions and/or products are to be declared via one or more input units 208. Each input unit 208 may be a unit configured to receive input from the consumer 102 using one or more methods. Input units 208 may include a mouse, keyboard, click wheel, scroll wheel, touch screen, microphone, camera, etc. The input unit 208 may convey the input data to the processing unit 204. The processing unit 204 may use the input data to identify transactions and/or products that are to be declared based on the consumer's selection and/or confirmation.

The processing unit 204 may also be configured to calculate a duty amount. In some embodiments, the duty amount may be calculated on a per transaction and/or product basis. In other embodiments, the duty amount may be calculated for the declared transactions and/or products as a whole. In some instances, the duty amount may be displayed to the consumer 102 via the display unit 210 during selection of declared transactions and/or products. In such instances, the processing unit 204 may calculate a new duty amount based on the selections each time the consumer 102 changes his or her selection. In other instances, the processing unit 204 may await calculation of an overall duty amount until the consumer 102 has finalized their selection.

The mobile device 108 may also include a transmitting unit 206. The transmitting unit 206 may be configured to transmit data over one or more networks via one or more network protocols. For example, the transmitting unit 206 may be configured to transmit a request to the processing server 110 for transaction data, such as upon entry of the mobile device 108 in the destination country. In another example, the transmitting unit 206 may be configured to transmit a request for rules and/or regulations to the regulatory agency 106, such as for use in identifying declarations or calculating duty amounts. In some embodiments, the transmitting unit 206 may also be configured to transmit payment details to the regulatory agency 106 or a payment network 110 for payment of a duty amount. In such embodiments, payment details may be input by the consumer 102, such as via the input unit 208, or read from a memory 216 in the mobile device 108, such as in a wallet application program.

The memory 216 may be configured to store data suitable for performing the functions of the mobile device 108 as discussed herein. For example, the memory 216 may store rules and/or algorithms for the identification of declared transactions and/or products, rules and/or algorithms for the calculation of duty amounts, algorithms for the generation of machine-readable codes encoded with declaration and/or payment data, program code for application programs, payment details for one or more payment methods, etc. Additional data that may be stored in the memory 216 will be apparent to persons having skill in the relevant art.

In some embodiments, the processing unit 204 may be further configured to generate machine-readable codes for presentation to the regulatory agency 106 or an agent thereof. For example, the processing unit 204 may generate a machine-readable code, such as a bar code or a quick response (QR) code, encoded with product and/or transaction data, duty amounts, payment methods, etc. The display unit 210 may then display the machine-readable code, which may be read by an agent of the regulatory agency 106 during the customs process to convey the consumer's declarations to the regulatory agency 106. In some instances, the transmitting unit 206 may be configured to transmit the information to the regulatory agency 106, such as via near field communication, Bluetooth, radio frequency communication, etc.

### Process for Assisted Declaration of Goods and Transactions

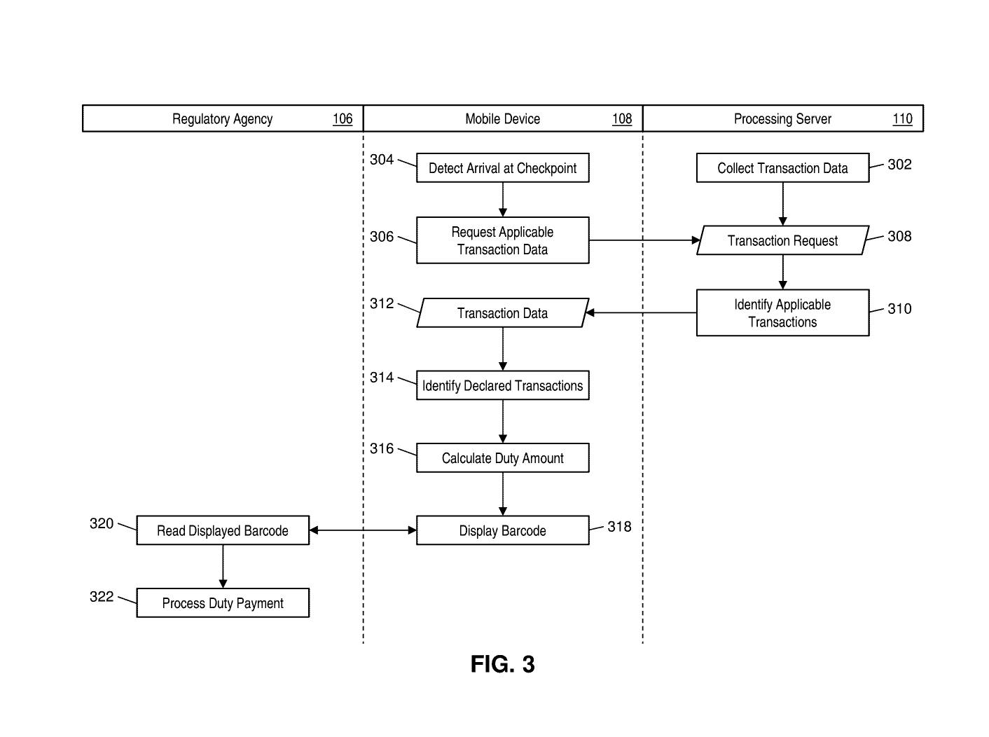

FIG. 3 illustrates a process for the assisted declarations of goods and transactions using the system 100.

In step 302, the processing server 110 may collect transaction data for a plurality of payment transactions involving the consumer 102, such as from the payment network 112, merchants 104, the mobile device 108, etc. In step 304, the mobile device 108 may detect arrival at a checkpoint. Arrival at the checkpoint may be detected using GPS, the scanning of a machine-readable code displayed at the checkpoint, mobile communication network triangulation, etc. In some instances, the detection may be performed by the processing server 110 or a third party, such as a mobile network operator associated with the mobile device 108. For example, the detection may be identified via the connection of the mobile device 108 to a different mobile communication network (e.g., different from in the visited country).

In step 306, the transmitting unit 206 of the mobile device 108 may transmit a request for applicable transaction data to the processing server 110. The request may include at least a range of transaction times and/or dates and one or more account and/or consumer identifiers, and may also include a geographic area or location (e.g., country). In step 308, the processing server 110 may receive the transaction data request. In embodiments where the processing server 110 may detect arrival of the mobile device 108 at the checkpoint, steps 306 and 308 may occur internally in the processing server 110.

In step 310, the processing server 110 may identify applicable transactions. Applicable transactions may include transactions involving the consumer 102 associated with the mobile device 108 that were conducted during the transaction times and/or dates, and, if identified, in the indicated geographic area or location. Transactions involving the consumer 102 may be identified via the account and/or consumer identifiers included in the request, such as account numbers, usernames, email address, phone numbers, etc. that may be include in transaction messages associated with the transactions. Once the transactions are identified, in step 312 transaction data for the applicable transactions may be transmitted to the mobile device 108 and received by the receiving unit 202. In some embodiments, the processing unit 204 of the mobile device 108 may store the received transaction data as transaction data entries 214 in the transaction database 212.

In step 314, the mobile device 108 may identify declared transactions and/or products. The declaration of transactions and/or products may be performed by the processing unit 204 (e.g., using rules and/or algorithms stored in the memory 216), or by the consumer 102 via the input unit 208 following display of the applicable transactions and/or products to the consumer 102 via the display unit 210. Once the transactions and/or products that are being declared are identified, then, in step 316, the processing unit 204 may calculate a duty amount. The duty amount may be calculated based on amounts for the declared transactions and/or products and rules and/or algorithms stored in the memory 216. In some instances, the duty amount may be specific to the destination country to which the duty is to be owed.

In step 318, the processing unit 204 may generate a barcode encoded with at least the duty amount, which may be displayed by the display unit 210. In some instances, the barcode may be encoded with additional data, such as transaction data associated with the declared transactions and/or products, payment details, consumer identification data (e.g., passport identifier, name, address, travel details, etc.). In step 320, the regulatory agency 106 may read the barcode and obtain the encoded information. In step 322, the regulatory agency 106 may process a payment for the duty amount. In instances where the barcode includes payment details, the regulatory agency 106 may process the payment using the included payment details and without any additional actions to be performed by the consumer 102. In other instances, the regulatory agency 106 (e.g., or an agent thereof) may request payment details from the consumer 102 for the calculated duty amount.

### Process for Assisted Declarations and Payments of Duty Amounts

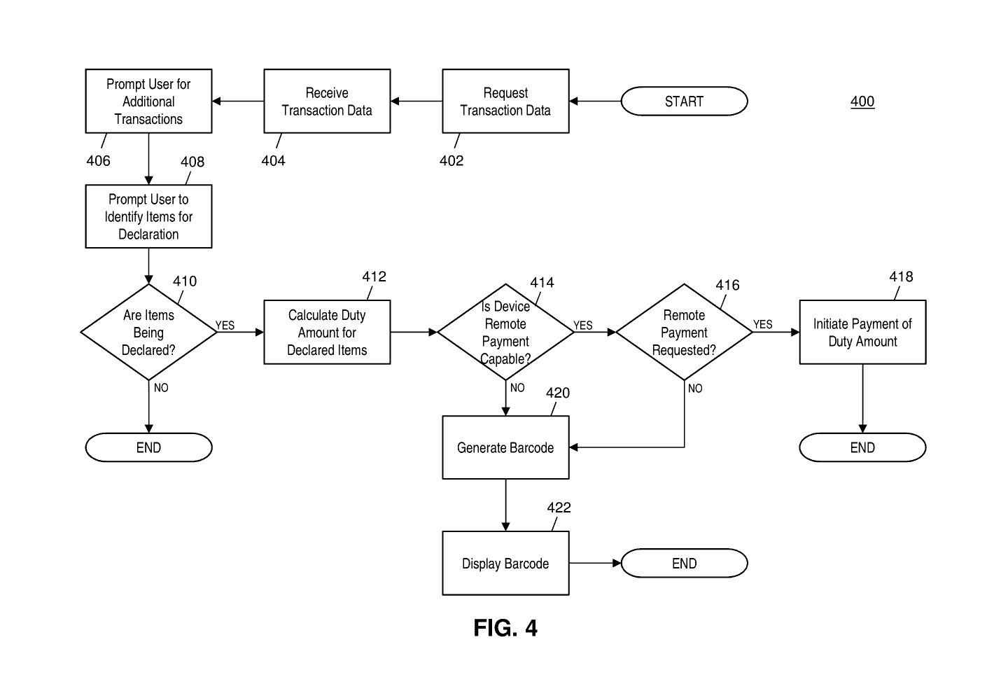

FIG. 4 illustrates a process 400 for the assisted declaration of transactions and/or products at customs and the calculation and payment of duty amounts using the mobile device 108.

In step 402, the transmitting unit 206 of the mobile device 108 may transmit a request for transaction data to the processing server 110. The request may include one or more account identifiers and may include additional data if necessary, such as a period of time, a geographic location, etc. In some instances, the request may be transmitted automatically via identification of the geographic location of the mobile device 108 by the processing unit 204 of the mobile device 108. In other instances, the request may be initiated by the consumer 102, such as via an input unit 208 of the mobile device 108.

In step 404, the receiving unit 202 of the mobile device 108 may receive transaction data. The transaction data may be data associated with a plurality of payment transactions involving the consumer 102 that may be foreign transactions (e.g., conducted outside of the destination country). In step 406, the consumer 102 may be prompted (e.g., via the display unit 210 of the mobile device 108) to enter information for any additional transactions. Additional transactions may include transactions that were not provided to the mobile device 108 by the processing server 110, such as transactions conducted using cash or other transactions that may not have been processed by a payment network 112 or other data source from which the processing server 110 obtains transaction data. In some instances, the prompt to the consumer 102 may include information to assist the consumer 102 in identifying applicable transactions, such as declaration rules, etc.

In step 408, the consumer 102 may be prompted to identify products for declaration via the display unit 210. The prompt may be for the consumer 102 to identify products purchased in the applicable transactions that are to be declared, based on rules set forth by the regulatory agency 106 in the destination country. For instance, the consumer 102 may not be required to pay a duty amount for entire transactions, but only for products that must be declared. For example, a single transaction may be for the purchase of both food items and a souvenir, but the consumer 102 may only be required to pay a duty for the souvenir if they already disposed of the food items before traveling to the destination country. In some embodiments, the processing unit 204 may pre-select or recommend products, based on the rules or regulations.

Once the consumer 102 has provided their selection of declared items, via the input unit 208, then, in step 410, the processing unit 204 may determine if any items are being declared. If no items are being declared, then the process 400 may be completed as the consumer 102 may not be declaring any items to the regulatory agency 106. In some instances, the process 400 may further include the transmitting of a notification (e.g., via the transmitting unit 206, display unit 210, or other suitable method) to the regulatory agency 106 or an agent thereof indicating that the consumer 102 has no items to declare.

If, in step 410, the processing unit 204 determines that there are items to declare, then, in step 412, the processing unit 204 may calculate a duty amount for the declared items. The duty amount may be based on product amounts associated with each of the items (e.g., as included in the received transaction data or input by the consumer 102) as well as rules and/or algorithms stored in the memory 216 and based on the rules or regulations of the regulatory agency 106. In step 414, the processing unit 204 may determine if the mobile device 108 is capable for performing a remote payment. If the mobile device 108 is capable, then, in step 416, the processing unit 204 may determine if remote payment is requested. Remote payment may be requested by the consumer 102 (e.g., via the input unit 208) or by the regulatory agency 106, such as via a request transmitted to the mobile device 108 and received by the receiving unit 202.

If remote payment is requested, then, in step 418, the processing unit 204 may initiate a payment transaction for payment of the duty amount to the regulatory agency 106 or other suitable entity. The payment transaction may be funded via payment details provided by the consumer 102 (e.g., via the input unit 208) or payment details identified by or stored in the mobile device 108, such as read from a payment card or stored in a mobile wallet application program. If remote payment is not requested, or if, in step 414, it is determined that the mobile device 108 is not capable of remote payment, then, in step 420, the processing unit 204 may generate a barcode.

The generated barcode may be encoded with data associated with the consumer's declared items, such as a list of the declared items, their values, their associated duty amounts, the calculated overall duty amount, payment details, etc. In step 422, the display unit 210 may display the barcode for reading by the regulatory agency 106, which may convey the encoded information to the regulatory agency 106.

### Graphical User Interface

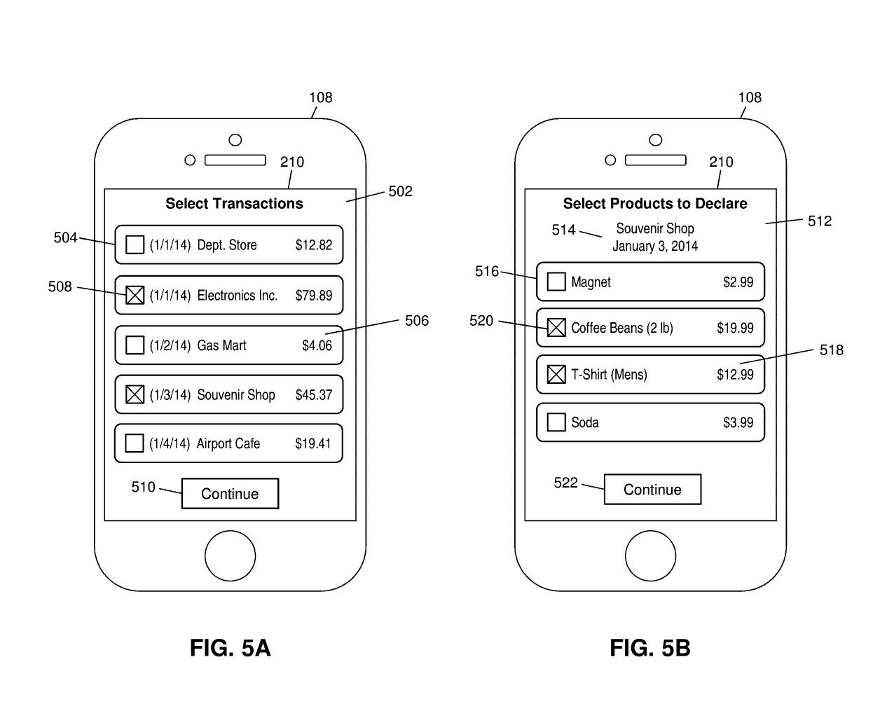

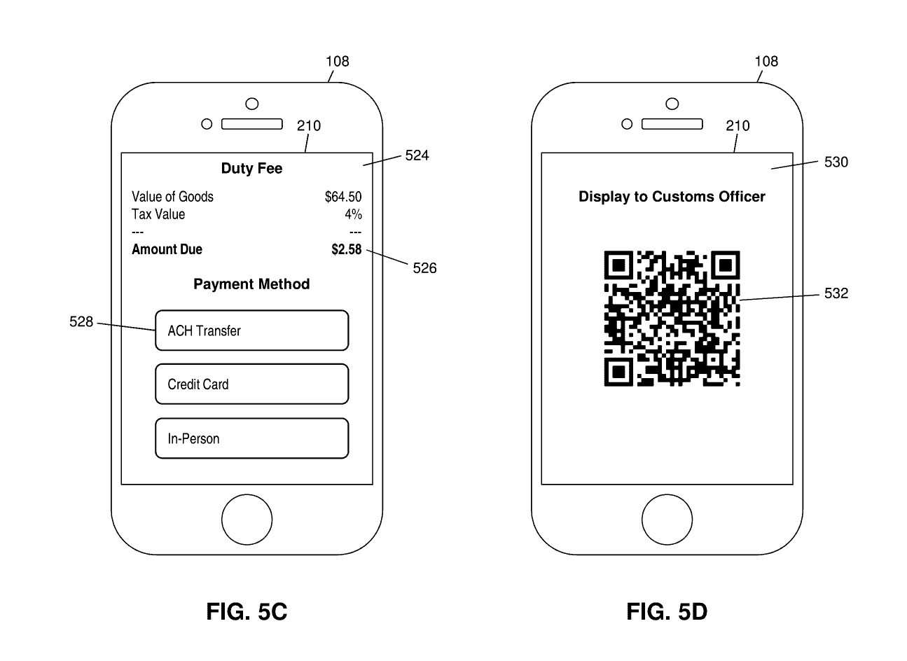

FIGS. 5A-5D illustrate an exemplary graphical user interface for the mobile device 108 for performing the methods and systems discussed herein. It will be apparent to persons having skill in the relevant art that the interfaces illustrated in FIGS. 5A-5D and discussed herein are provided as illustrations only, and that additional and/or alternative configurations and interfaces may be suitable in performing the methods and systems discussed herein.

FIG. 5A illustrates a transaction selection screen 502, displayed by the display unit 210 of the mobile device 108. The transaction selection screen 502 may include a plurality of transactions 504. Each transaction 504 may include transaction details 506, such as a transaction date, a merchant name, and a transaction amount as illustrated in FIG. 5A. Each transaction 504 may also include a selector 508. The selector 508 may be a checkbox or other suitable selection method for selection by the consumer 102, and/or preselection by the processing unit 204, to indicate which transaction needs to be declared and/or includes products that are to be declared. In the example illustrated in FIG. 5A, two transactions 504 have selectors 508 indicating that they are to be declared or were for the purchase of products or services that are to be declared. The transaction selection screen 502 may also include a continue button 510. The continue button 510, when interacted with by the consumer 102, may take the consumer 102 to a product declaration screen 512, illustrated in FIG. 5B.

The product declaration screen 512, displayed by the display unit 210 of the mobile device 108, may be used by the consumer 102 to select products purchased as part of an indicated transaction for declaration. The product declaration screen 512 may include transaction details 514, which may correspond to the transaction selected by the consumer 102 (e.g., from the transaction selection screen 502). For instance, in the example illustrated in FIG. 5B, the transaction details 514 indicate that the display products correspond to the second transaction 504 selected from the transaction selection screen 502.

The product declaration screen 512 may also include one or more products 516. Each product 516 may include product details 518, which may include a product name, any additional product data, and a product amount. The product amount may be used in the calculation of a duty amount owed for declared items. Each product 516 may also include a selector 520. The selector 520 may be used by the consumer 102 (e.g., or the processing unit 204) to indicate which products purchased in the transaction are to be declared. In the example illustrated in FIG. 5B, the consumer 102 is declaring coffee beans and a t-shirt. The product declaration screen 512 may also include a continue button 522, which, when interacted with by the consumer 102, may present the consumer 102 with the duty amount screen 524, illustrated in FIG. 5C.

The duty amount screen 524 illustrated in FIG. 5C, and displayed on the mobile device 108 via the display unit 210, may display a duty amount 526. The duty amount 526 may be the amount calculated by the processing unit 204 using applicable rules and/or algorithms as applied to the product amounts for each of the items declared by the consumer 102. As illustrated in FIG. 5C, the duty amount 526 may be accompanied by data indicating how the duty amount 526 was calculated. The duty amount screen 524 may also include payment methods 528. Each payment method 528 may be a button that the consumer 102 may interact with to indicate how the consumer 102 wants to pay for the duty amount 526. In the example illustrated in FIG. 5C, the consumer 102 may pay via an automated clearing house (ACH) transfer, via credit card, or in-person to an agent of the regulatory agency 106.

FIG. 5D illustrates a barcode display screen 530. The barcode display screen 530 may be displayed by the display unit 210 of the mobile device 108 for presentation to the regulatory agency 106 and a device or agent thereof. The barcode display screen 530 may include a barcode 532. The barcode 532 may be encoded with data suitable for use in the customs process, such as the calculated duty amount 526, transaction details 506 for selected transactions, product details 518 for selected products, payment details, etc. The barcode 532 may be read by the regulatory agency 106 to convey the data to the regulatory agency 106, which the agency may thereby use in the customs process.

### Exemplary Method for Assisted Declaration of Goods at Customs

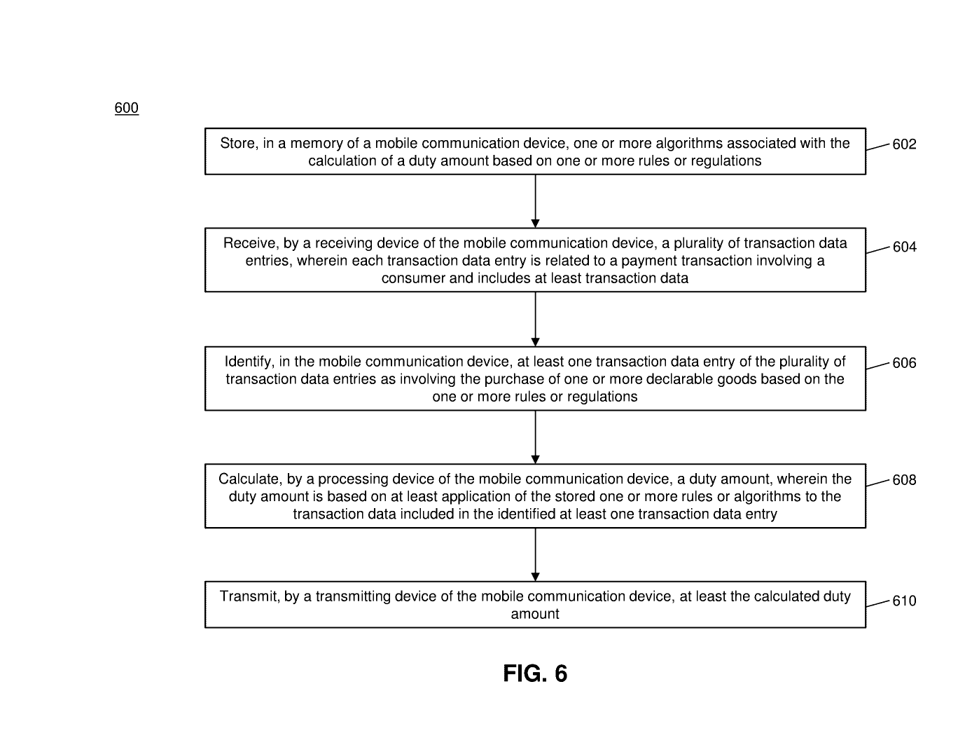

FIG. 6 illustrates a method 600 for the assisted declaration of goods at customs using a mobile device configured to receive transaction data for foreign transactions.

In step 602, one or more algorithms associated with the calculation of a duty amount based on one or more regulations may be stored in a memory (e.g., the memory 216) of a mobile communication device (e.g., the mobile device 108). In step 604, a plurality of transaction data entries (e.g., transaction data entries 214) may be received by a receiving device (e.g., the receiving unit 202) of the mobile communication device 108, wherein each transaction data entry 214 is related to a payment transaction involving a consumer (e.g., the consumer 102) and includes at least transaction data.

In step 606, at least one transaction data entry 214 of the plurality of transaction data entries may be identified in the mobile communication device 108 as involving the purchase of one or more declarable goods based on the one or more rules or regulations. In some embodiments, the at least one transaction data entry 214 identified as involving the purchase of one or more declarable goods may be indicated in the received plurality of transaction data entries. In one embodiment, the memory 216 is further configured to store one or more declaration rules or algorithms, and identifying at least one transaction data entry includes identifying the at least one transaction data entry 214 based on an application of the one or more declaration rules or algorithms to the transaction data included in the respective transaction data entry.

In step 608, a duty amount may be calculated by a processing device (e.g., the processing unit 204) of the mobile communication device 108, wherein the duty amount is based on at least application of the stored one or more rules or algorithms to the transaction data included in the identified at least one transaction data entry. In step 610, at least the calculated duty amount may be transmitted by a transmitting device (e.g., the transmitting unit 206) of the mobile communication device 108.

In one embodiment, the method 600 may further include receiving, by an input device (e.g., the input unit 208) of the mobile communication device 108, transaction data for at least one additional transaction data entry, wherein the at least one additional transaction data entry is included in the identified at least one transaction data entry 214. In a further embodiment, each of the plurality of transaction data entries 214 is associated with a transaction account associated with the consumer 102, and wherein the at least one additional transaction data entry is related to a cash payment transaction. In some embodiments, the at least one transaction data entry 214 identified as involving the purchase of one or more declarable goods is identified via receiving, by the input device 208 of the mobile communication device 108, user input indicating the at least one transaction data entry.

In some embodiments, the transaction data may include product data associated with one or more goods purchased in the related payment transaction, the memory 216 may be further configured to store one or more declaration rules, and identifying at least one transaction data entry 214 may include identifying the at least one transaction data entry 214 based on the product data included in the respective transaction data entry and the stored one or more declaration rules. In a further embodiment, the duty amount may be based on the application of the stored one or more rules or algorithms to the product data included in the identified at least one transaction data entry. In an even further embodiment, the one or more rules or algorithms may be applied to product data associated with declarable goods as indicated by the stored one or more declaration rules.

In one embodiment, the calculated duty amount may be transmitted to an external computing device configured to print a customs form associated with the one or more rules or regulations. In some embodiments, the calculated duty amount may be transmitted to a payment network (e.g., the payment network 112) for the initiation of a payment transaction to an entity (e.g., the regulatory agency 106) associated with the one or more rules or regulations for the calculated duty amount. In one embodiment, the memory 216 may be further configured to store payment credentials associated with a transaction account, and transmitting the calculated duty amount may include transmitting the stored payment credentials.

### Computer System Architecture

FIG. 7 illustrates a computer system 700 in which embodiments of the present disclosure, or portions thereof, may be implemented as computer-readable code. For example, the mobile device 108 and processing server 110 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 4, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for assisting with declarations for customs. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for assisted declaration of goods at customs, comprising:
storing, in a memory of a mobile communication device, one or more algorithms associated with the calculation of a duty amount based on one or more rules or regulations;
receiving, by a receiving device of the mobile communication device, a plurality of transaction data entries, wherein each transaction data entry is related to a payment transaction involving a consumer and includes at least transaction data;
identifying, in the mobile communication device, at least one transaction data entry of the plurality of transaction data entries as involving the purchase of one or more declarable goods based on the one or more rules or regulations;
calculating, by a processing device of the mobile communication device, a duty amount, wherein the duty amount is based on at least application of the stored one or more rules or algorithms to the transaction data included in the identified at least one transaction data entry; and
transmitting, by a transmitting device of the mobile communication device, at least the calculated duty amount.

2. The method of claim 1, further comprising:
receiving, by an input device of the mobile communication device, transaction data for at least one additional transaction data entry, wherein the at least one additional transaction data entry is included in the identified at least one transaction data entry.

3. The method of claim 2, wherein each of the plurality of transaction data entries is associated with a transaction account associated with the consumer, and wherein the at least one additional transaction data entry is related to a cash payment transaction.

4. The method of claim 1, wherein the at least one transaction data entry identified as involving the purchase of one or more declarable goods is identified via receiving, by an input device of the mobile communication device, user input indicating the at least one transaction data entry.

5. The method of claim 1, wherein the at least one transaction data entry identified as involving the purchase of one or more declarable goods is indicated in the received plurality of transaction data entries.

6. The method of claim 1, wherein
the memory is further configured to store one or more declaration rules or algorithms, and
identifying at least one transaction data entry as involving the purchase of one or more declarable goods includes identifying, by the processing device of the mobile communication device, the at least one transaction data entry based on application of the one or more declaration rules or algorithms to the transaction data included in the respective transaction data entry.

7. The method of claim 1, wherein
the transaction data includes product data associated with one or more goods purchased in the related payment transaction,
the memory is further configured to store one or more declaration rules, and
identifying at least one transaction data entry as involving the purchase of one or more declarable goods includes identifying, by the processing device of the mobile communication device, the at least one transaction data entry based on the product data included in the respective transaction data entry and the stored one or more declaration rules.

8. The method of claim 7, wherein the duty amount is based on the application of the stored one or more rules or algorithms to the product data included in the identified at least one transaction data entry.

9. The method of claim 8, wherein the one or more rules or algorithms are applied to product data associated with declarable goods as indicated by the stored one or more declaration rules.

10. The method of claim 1, wherein the calculated duty amount is transmitted to an external computing device configured to print a customs form associated with the one or more rules or regulations.

11. The method of claim 1, wherein the calculated duty amount is transmitted to a payment network for the initiation of a payment transaction to an entity associated with the one or more rules or regulations for the calculated duty amount.

12. The method of claim 1, wherein
the memory is further configured to store payment credentials associated with a transaction account, and
transmitting at least the calculated duty amount further includes transmitting the stored payment credentials.

13. A system for assisted declaration of goods at customs, comprising:
a memory of a mobile communication device configured to store one or more algorithms associated with the calculation of a duty amount based on one or more rules or regulations;
a receiving device of the mobile communication device configured to receive a plurality of transaction data entries, wherein each transaction data entry is related to a payment transaction involving a consumer and includes at least transaction data;
a processing device of the mobile communication device configured to
identify at least one transaction data entry of the plurality of transaction data entries as involving the purchase of one or more declarable goods based on the one or more rules or regulations, and
calculate a duty amount, wherein the duty amount is based on at least application of the stored one or more rules or algorithms to the transaction data included in the identified at least one transaction data entry; and
a transmitting device of the mobile communication device configured to transmit at least the calculated duty amount.

14. The system of claim 13, further comprising:
an input device of the mobile communication device configured to receive transaction data for at least one additional transaction data entry, wherein the at least one additional transaction data entry is included in the identified at least one transaction data entry.

15. The system of claim 14, wherein each of the plurality of transaction data entries is associated with a transaction account associated with the consumer, and wherein the at least one additional transaction data entry is related to a cash payment transaction.

16. The system of claim 13, wherein the at least one transaction data entry identified as involving the purchase of one or more declarable goods is identified via receiving, by an input device of the mobile communication device, user input indicating the at least one transaction data entry.

17. The system of claim 13, wherein the at least one transaction data entry identified as involving the purchase of one or more declarable goods is indicated in the received plurality of transaction data entries.

18. The system of claim 13, wherein
the memory is further configured to store one or more declaration rules or algorithms, and
identifying at least one transaction data entry as involving the purchase of one or more declarable goods includes identifying, by the processing device of the mobile communication device, the at least one transaction data entry based on application of the one or more declaration rules or algorithms to the transaction data included in the respective transaction data entry.

19. The system of claim 13, wherein
the transaction data includes product data associated with one or more goods purchased in the related payment transaction,
the memory is further configured to store one or more declaration rules, and
identifying at least one transaction data entry as involving the purchase of one or more declarable goods includes identifying, by the processing device of the mobile communication device, the at least one transaction data entry based on the product data included in the respective transaction data entry and the stored one or more declaration rules.

20. The system of claim 19, wherein the duty amount is based on the application of the stored one or more rules or algorithms to the product data included in the identified at least one transaction data entry.

21. The system of claim 20, wherein the one or more rules or algorithms are applied to product data associated with declarable goods as indicated by the stored one or more declaration rules.

22. The system of claim 13, wherein the calculated duty amount is transmitted to an external computing device configured to print a customs form associated with the one or more rules or regulations.

23. The system of claim 13, wherein the calculated duty amount is transmitted to a payment network for the initiation of a payment transaction to an entity associated with the one or more rules or regulations for the calculated duty amount.

24. The system of claim 13, wherein
the memory is further configured to store payment credentials associated with a transaction account, and
transmitting at least the calculated duty amount further includes transmitting the stored payment credentials.
